(19) United States
(12) Patent Application Publication
(10) Pub. No.: US 2026/0322638 A1
(43) Pub. Date: Oct. 15, 2026

(54) Network aware power management

(71) Applicant: Mellanox Technologies, Ltd., Yokneam (IL)

(72) Inventors: Michael Weiner, Nes Ziona (IL); Yuval Shpigelman, Netanya (IL); Idan Borshteen, Carmiel (IL)

(21) Appl. No.: 19/177,672

(22) Filed: Apr. 14, 2025

Related U.S. Application Data
(60) Provisional application No. 63/633,390, filed on Apr. 12, 2024.

(51) Int. Cl. H04L 12/10; H04L 47/20

(52) U.S. Cl. CPC H04L 12/10; H04L 47/20

(57) ABSTRACT

In one embodiment, a system for managing network devices comprises a power management subsystem to allocate power budgets to the network devices, a network traffic control subsystem to manage network traffic among the network devices, and a communication interface between the power management subsystem and the network traffic control subsystem, wherein the power management subsystem is to send power allocation decisions to the network traffic control subsystem, and the network traffic control subsystem is to adjust network traffic control based on the received power allocation decisions.

### FIELD OF INVENTION

The present disclosure relates to computing systems, and more particularly but not exclusively to power and network management.

### BACKGROUND

Data centers are complex computing environments that require efficient management of power and network resources. These facilities house numerous interconnected devices, including servers, switches, and storage systems, which collectively consume substantial amounts of energy. As data center operations continue to expand and evolve, the demand for computational power and network bandwidth increases, leading to greater energy consumption.

Power management in data centers involves allocating and distributing electrical power across various components and systems. This process aims to optimize energy utilization while maintaining performance and reliability. Effective power management can help reduce operational costs, minimize environmental impact, and extend the lifespan of hardware components.

Network traffic control is another aspect of data center management that focuses on regulating the flow of data between devices and systems. This includes managing network congestion, prioritizing traffic, ensuring efficient utilization of available bandwidth, and routing decisions. Proper network traffic control can enhance overall system performance, reduce latency, and improve the user experience for applications hosted within the data center.

### OVERVIEW

There is provided in accordance with an embodiment of the present disclosure, a system for managing network devices, comprising a power management subsystem to allocate power budgets to the network devices, a network traffic control subsystem to manage network traffic among the network devices, and a communication interface between the power management subsystem and the network traffic control subsystem, wherein the power management subsystem is to send power allocation decisions to the network traffic control subsystem, and the network traffic control subsystem is to adjust network traffic control based on the received power allocation decisions.

Further in accordance with an embodiment of the present disclosure, the network traffic control subsystem is to send network traffic information to the power management subsystem, and the power management subsystem is to generate additional power allocation decisions based on the received network traffic information.

Still further in accordance with an embodiment of the present disclosure, the network traffic information includes congestion control data, and the power management subsystem is to generate the additional power allocation decisions based on the received congestion control data.

Additionally, in accordance with an embodiment of the present disclosure, the network traffic information includes network traffic statistics, the power management subsystem is to generate the additional power allocation decisions based on the received network traffic statistics.

Moreover, in accordance with an embodiment of the present disclosure, the network traffic control subsystem includes a congestion controller to adjust data flow rates based on the received power allocation decisions.

Further in accordance with an embodiment of the present disclosure, the network traffic control subsystem includes a routing controller to make network routing decisions based on the received power allocation decisions.

Still further in accordance with an embodiment of the present disclosure, the power management subsystem is to dynamically reallocate power budgets among the network devices.

Additionally, in accordance with an embodiment of the present disclosure, the system is implemented in a data center environment to manage power consumption and network performance across multiple server racks and network devices.

Moreover, in accordance with an embodiment of the present disclosure, the power management subsystem is to send early notifications of impending power budget changes to the network traffic control subsystem, and the network traffic control subsystem is to proactively adjust network parameters based on the early notifications.

Further in accordance with an embodiment of the present disclosure, the network traffic control subsystem is to proactively adjust transmission rates based on the early notifications.

Still further in accordance with an embodiment of the present disclosure, the power management subsystem is to coordinate power state changes in the network devices with the network traffic control subsystem to avoid race conditions and improve overall system performance.

Additionally in accordance with an embodiment of the present disclosure, the network devices include the network traffic control subsystem.

Moreover, in accordance with an embodiment of the present disclosure, the power management subsystem is to provide multiple levels of power management and includes a centralized power governor, and distributed power management controllers disposed in the network devices.

Further in accordance with an embodiment of the present disclosure, the centralized power governor is implemented at a datacenter level or a rack level.

There is provided in accordance with another embodiment of the present disclosure, a system for managing network devices, comprising a power management subsystem to allocate power budgets to the network devices, a network traffic control subsystem to manage network traffic among the network devices, and a communication interface between the power management subsystem and the network traffic control subsystem, wherein the network traffic control subsystem is to send network traffic information to the power management subsystem, and the power management subsystem is to generate power allocation decisions based on the received network traffic information and send the power allocation decisions to the network traffic control subsystem.

Further in accordance with an embodiment of the present disclosure, the network traffic information includes congestion control data, and the power management subsystem is to generate the power allocation decisions based on the received congestion control data.

Still further in accordance with an embodiment of the present disclosure, the network traffic information includes network traffic statistics, and the power management subsystem is to generate the power allocation decisions based on the received network traffic statistics.

Additionally, in accordance with an embodiment of the present disclosure, the network traffic control subsystem includes a congestion controller to adjust data flow rates based on the received power allocation decisions.

Moreover, in accordance with an embodiment of the present disclosure, the network traffic control subsystem includes a routing controller to make network routing decisions based on the received power allocation decisions.

Further in accordance with an embodiment of the present disclosure, the power management subsystem is to dynamically reallocate power budgets among the network devices.

Still further in accordance with an embodiment of the present disclosure, the system is implemented in a data center environment to manage power consumption and network performance across multiple server racks and network devices.

Additionally in accordance with an embodiment of the present disclosure, the power management subsystem is to send early notifications of impending power budget changes to the network traffic control subsystem, and the network traffic control subsystem is to proactively adjust network parameters based on the early notifications.

Moreover, in accordance with an embodiment of the present disclosure, the network traffic control subsystem is to proactively adjust transmission rates based on the early notifications.

Further in accordance with an embodiment of the present disclosure, the power management subsystem is to coordinate power state changes in the network devices with the network traffic control subsystem to avoid race conditions and improve overall system performance.

Still further in accordance with an embodiment of the present disclosure, the network devices include the network traffic control subsystem.

Additionally in accordance with an embodiment of the present disclosure, the power management subsystem is to provide multiple levels of power management and includes a centralized power governor, and distributed power management controllers disposed in the network devices.

Moreover, in accordance with an embodiment of the present disclosure, the centralized power governor is implemented at a datacenter level or a rack level.

There is also provided in accordance with still another embodiment of the present disclosure, a method for managing network devices, comprising allocating power budgets to the network devices using a power management subsystem, managing network traffic among the network devices using a network traffic control subsystem, sending power allocation decisions from the power management subsystem to the network traffic control subsystem through a communication interface, and adjusting network traffic control by the network traffic control subsystem based on the received power allocation decisions.

There is also provided in accordance with still another embodiment of the present disclosure, a method for managing network devices, comprising allocating power budgets to the network devices using a power management subsystem, managing network traffic among the network devices using a network traffic control subsystem, sending network traffic information from the network traffic control subsystem to the power management subsystem through a communication interface, generating power allocation decisions by the power management subsystem based on the received network traffic information, and sending the power allocation decisions from the power management subsystem to the network traffic control subsystem.

### BRIEF DESCRIPTION OF THE DRAWINGS

The present disclosure will be understood from the following detailed description, taken in conjunction with the drawings in which:

FIG. 1 is a simplified block diagram of a system for coordinating power management and network traffic control, in accordance with an embodiment of the present disclosure;

FIG. 2 is a more detailed block diagram of components within the system of FIG. 1, according to an aspect of the present disclosure;

FIG. 3 is a simplified block diagram of a power governor in the system of FIG. 2;

FIG. 4 is a simplified block diagram of a network orchestrator in the system of FIG. 2;

FIG. 5 is a simplified block diagram of a network device in the system of FIG. 2;

FIG. 6 is a flowchart illustrating a method for managing power allocation in a network system, according to an embodiment;

FIG. 7 is a flowchart illustrating a method for managing network traffic in response to power allocation decisions, in accordance with an embodiment of the present disclosure; and

FIG. 8 is a block diagram that schematically illustrates a computing system, e.g., a data center or a High-Performance Computing (HPC) cluster, in accordance with an embodiment of the present disclosure.

### DESCRIPTION OF EXAMPLE EMBODIMENTS

### OVERVIEW OF EXAMPLE EMBODIMENTS

Existing data center management systems often treat power allocation and network traffic control as separate domains, leading to inefficiencies and suboptimal resource utilization. Power management systems typically make decisions based on thermal constraints, workload distribution, and energy efficiency goals without considering the current state of network congestion or traffic patterns. Similarly, network traffic control mechanisms focus on parameters like bandwidth utilization and latency requirements without accounting for power allocation decisions.

This disconnect can result in several problems. For instance, power allocation decisions may inadvertently create network bottlenecks by reducing power to critical network components during periods of high traffic. Conversely, network congestion may lead to increased power consumption in certain devices without the power management system being aware of or able to respond to these changes. The lack of coordination between these systems can lead to performance degradation, inefficient use of resources, and potential conflicts between power and network optimization goals.

Possible solutions to address these issues might include implementing a centralized management system that oversees both power and network resources. However, such an approach could introduce single points of failure and may not be sufficiently responsive to rapid changes in network conditions or power demands occurring at the local level of the network. Another option could be to implement local optimization algorithms on individual devices, but this may lead to suboptimal global performance and potential conflicts between devices.

Embodiments of the present disclosure address at least some of the above drawbacks by providing a system that enables bidirectional communication and coordination between power management and network traffic control subsystems.

In some embodiments, the system includes a power management subsystem that can send power allocation decisions to a network traffic control subsystem. This allows the network traffic control subsystem to proactively adjust its operations based on anticipated changes in power distribution across network devices.

In some cases, the power management subsystem may send early notifications of impending power budget changes to the network traffic control subsystem, allowing the network traffic control subsystem to preemptively adjust parameters such as data flow rates and routing decisions. This proactive approach can help minimize disruptions to network performance during power reallocation events. For example, if the power management subsystem anticipates a reduction in power allocation to a specific network switch due to thermal constraints, it may notify the network traffic control subsystem in advance. This early notification may allow the network traffic control subsystem to proactively adjust routing tables and redirect traffic flows to alternative paths, potentially avoiding congestion before it occurs.

In some implementations, the network traffic control subsystem may adjust transmission rates based on received power allocation decisions. For example, if the power management subsystem notifies the network traffic control subsystem of an impending reduction in power to a particular network interface, the network traffic control subsystem may proactively reduce the transmission rate on that interface.

This adjustment may involve lowering the link speed, such as transitioning from a 100 Gbps connection to a 50 Gbps or 25 Gbps connection. By reducing the transmission rate, the network device may be able to operate with lower power consumption while still maintaining connectivity. The network traffic control subsystem may also redistribute traffic loads across other available interfaces to compensate for the reduced capacity on the affected link.

In some cases, the network traffic control subsystem may implement adaptive bit rate techniques in response to power allocation decisions. For instance, if a server's power budget is decreased, the network traffic control subsystem may instruct the server to use more efficient encoding schemes for data transmission, potentially sacrificing some quality or performance in exchange for lower power consumption.

Additionally, the network traffic control subsystem may adjust packet scheduling algorithms based on power allocation decisions. When notified of reduced power availability, the system may prioritize critical traffic while delaying or throttling less important data flows. This approach may help maintain essential services while reducing overall network utilization and power consumption.

In some implementations, a network device that receives a power decision to reduce power may inform other network devices sending data to it to reduce their transmission rates. For example, a network switch may receive a power allocation decision from the power management subsystem indicating that its power budget will be reduced. In response, the switch may send messages to upstream devices, such as servers or other switches, requesting them to lower their transmission rates when sending data to this particular switch. This communication may be implemented using existing network protocols or custom messages.

Upon receiving these requests, the sending devices may adjust their transmission rates accordingly. This adjustment may involve reducing the frequency of packet transmissions, increasing inter-packet gaps, or employing more aggressive traffic shaping techniques. By coordinating these adjustments across multiple devices, the network may be able to maintain stability and prevent congestion while operating under reduced power conditions.

This approach may allow for a more distributed and responsive adaptation to power changes, potentially improving overall network efficiency and reducing the likelihood of packet loss or increased latency due to sudden power reductions in individual network devices.

In some implementations, the power management subsystem may provide information about power-saving modes that will be applied to certain network devices. For instance, if a group of servers is scheduled to enter a low-power state during off-peak hours, the network traffic control subsystem may use this information to preemptively adjust load balancing algorithms. By redistributing incoming requests to servers that will remain in full-power mode, the system may maintain optimal performance and avoid potential bottlenecks that could arise from reduced processing capacity in the power-saving servers.

In some cases, the network traffic control subsystem can send network traffic information, such as congestion data and traffic statistics, back to the power management subsystem. This feedback loop enables the power management subsystem to make more informed decisions about power allocation, taking into account the current state and needs of the network.

In some implementations, the power management subsystem may utilize network traffic statistics to optimize power allocation across network devices. For example, if the network traffic control subsystem reports consistently low utilization on certain network links or switches, the power management subsystem may reduce power allocation to those underutilized components. This may involve scaling down the operating frequency of network processors or placing certain ports or interfaces into a low-power state. By aligning power consumption with actual network usage patterns, the system may achieve improved energy efficiency without compromising overall network performance.

In other cases, the power management subsystem may leverage congestion control data to make dynamic power allocation decisions. For instance, if the network traffic control subsystem detects persistent congestion hotspots in specific areas of the network, the power management subsystem may temporarily increase power allocation to the affected devices. This additional power may enable network switches or routers to operate at higher clock speeds or activate additional processing cores, potentially alleviating the congestion by increasing packet processing capacity. As congestion levels subside, the power management subsystem may gradually reduce power allocation back to normal levels, thus maintaining an adaptive balance between performance needs and energy consumption.

Advantages of this solution include improved overall system efficiency, reduced likelihood of network congestion due to power-related issues, and more effective utilization of available power resources. The bidirectional information exchange allows for dynamic and responsive management of both power and network resources, adapting to changing conditions in real-time.

### SYSTEM DESCRIPTION

In some cases, the following definitions may apply to terms used throughout this disclosure:

Power sloshing may refer to a dynamic approach to power management that involves rapidly reallocating power budgets between different components in a system to maximize efficiency. Power sloshing may allow for strategic redistribution of power resources based on current workload demands and system utilization.

Network traffic control may refer to the management and optimization of data flow through a network. Network traffic control may encompass various techniques and mechanisms used to regulate, prioritize, and direct the transmission of data packets across network devices and links.

Congestion control may refer to a set of techniques and algorithms used to manage network traffic in order to prevent or mitigate network congestion. Congestion control may involve adjusting data transmission rates, implementing flow control mechanisms, and optimizing network resource utilization to maintain efficient network performance.

Routing may refer to the process of selecting paths for sending network traffic. Routing may involve determining the most efficient path for data to travel from a source to a destination across a network, taking into account factors such as network topology, link capacities, and traffic conditions.

Network device may refer to any hardware component or system that facilitates the transmission, routing, switching, or processing of network data. Network devices may include, but are not limited to, routers, switches, hubs, bridges, gateways, firewalls, and network interface controllers (NICs).

Power budget may refer to the amount of electrical power allocated to a particular component, device, or system within a larger infrastructure. Power budgets may be dynamically adjusted based on various factors such as network traffic information, workload, performance requirements, and overall power availability.

Network traffic information may refer to data and metrics related to the flow of information across a network. This may include statistics on data transmission rates, packet loss, latency, throughput, and other performance indicators that describe the state and behavior of network traffic.

Power allocation decision may refer to a determination made by a power management system regarding how to distribute available power resources among various components or devices in a network or computing environment. These decisions may be based on factors such as network traffic information, current workload, performance requirements, and overall system efficiency goals.

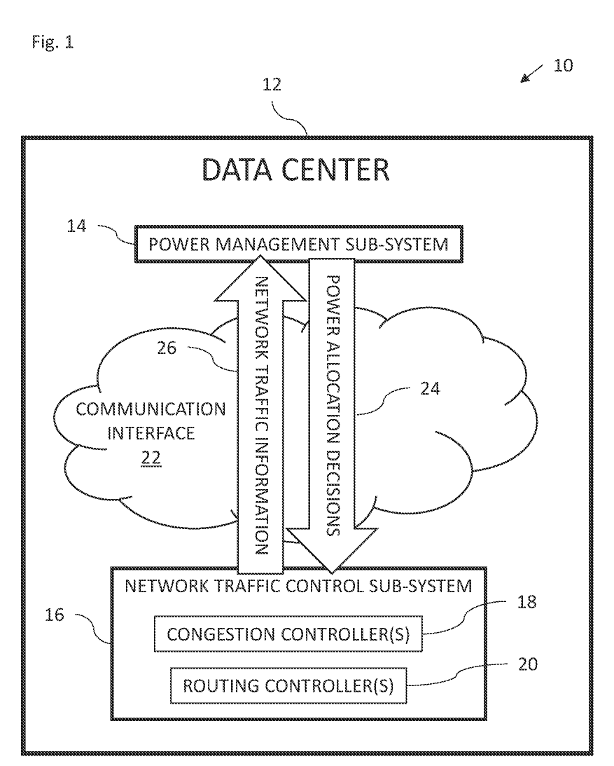

Reference is now made to FIG. 1, which is a block diagram illustrating a system implemented within a data center 12. The system may be part of a computer system 10 and may include a power management subsystem 14 and a network traffic control subsystem 16 that communicate through a communication interface 22.

The power management subsystem 14 may be configured to allocate power budgets to network devices within the data center 12. In some cases, the power management subsystem 14 may generate power allocation decisions 24 based on various inputs, including network traffic information received from the network traffic control subsystem 16.

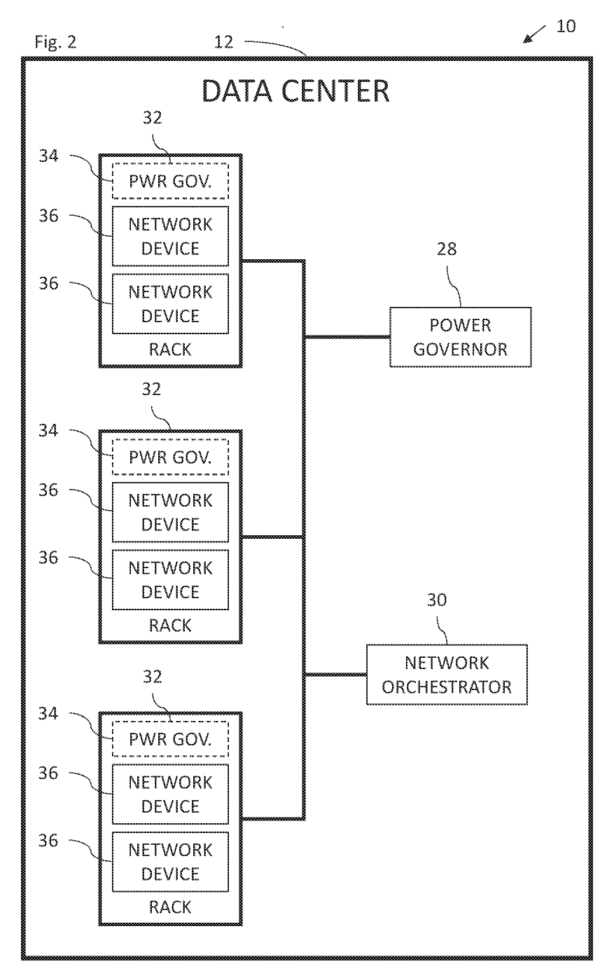

The network traffic control subsystem 16 may be responsible for managing network traffic among network devices in the data center 12. The network traffic control subsystem 16 may include at least one congestion controller 18 and at least one routing controller 20. The congestion controller 18 and routing controller 20 may manage different aspects of network traffic control for the network devices within the data center 12. The network traffic control subsystem 16 may be operative at different levels in the system, for example, at an orchestrator level and at a network device level, as described in more detail with reference to FIG. 2.

The communication interface 22 may enable bidirectional information exchange between the power management subsystem 14 and the network traffic control subsystem 16. Through the communication interface 22, power allocation decisions 24 may flow from the power management subsystem 14 to the network traffic control subsystem 16. In the opposite direction, network traffic information 26 may flow from the network traffic control subsystem 16 to the power management subsystem 14. The communication interface 22 may be implemented using a network connected via cables and/or a wireless communication network.

The power management subsystem 14 may generate power allocation decisions 24 based on received network traffic information 26. The network traffic control subsystem 16 may adjust network traffic parameters based on received power allocation decisions 24. This bidirectional communication may allow coordination between power management and network traffic control operations within the data center 12.

In some cases, the network traffic control subsystem 16 may send network traffic information 26 to the power management subsystem 14. The network traffic information 26 may include various types of data related to network performance and utilization. Upon receiving the network traffic information 26, the power management subsystem 14 may generate additional power allocation decisions 24 based on the received network traffic information 26.

The power management subsystem 14 may send the power allocation decisions 24 to the network traffic control subsystem 16 through the communication interface 22. Upon receiving the power allocation decisions 24, the network traffic control subsystem 16 may adjust network traffic control based on the received power allocation decisions 24. This adjustment may involve modifying parameters related to congestion control, routing, or other aspects of network traffic management.

Reference is now made to FIG. 2, which is a block diagram illustrating data center 12. While the data center 12 of FIG. 1 shows a high-level operation of the power management subsystem 14 and the network traffic control subsystem 16, FIG. 2 shows a multi-level power management system including various devices included in system 10 in accordance with an embodiment of the present disclosure. The data center 12 may include multiple racks 32 arranged in a suitable configuration. Each rack 32 may contain one or more network devices 36 that handle data processing and network communications. The network devices 36 may include network interface cards (NICs) and/or switches. The network devices 36 may be part of the network traffic control subsystem 16, which may be distributed among individual network devices 36.

The data center 12 may implement a multi-level power management structure. At the top level, a central power governor 28 may oversee power allocation across the data center 12. The central power governor 28 may be implemented at a datacenter level to manage power consumption and network performance across multiple racks 32 and network devices 36.

A network orchestrator 30 may interface with the central power governor 28 to coordinate network operations. The network orchestrator 30 may be part of the network traffic control subsystem 16.

Each rack 32 may include a rack power governor 34 that manages power distribution within that rack. In some cases, the central power governor 28 may be implemented at a rack level instead of or in addition to the datacenter level. The rack power governor 34 may communicate with the central power governor 28 and with the network devices 36 within its rack to control power allocation.

The power management subsystem 14 may provide multiple levels of power management, including a centralized power governor (e.g., central power governor 28 and/or rack power governors 34) and distributed power management controllers disposed in the network devices 36. This multi-level structure enables power management across the data center 12 from the highest level down to individual network devices 36.

The network devices 36 may be arranged within each rack 32 to process network traffic and handle data communications. The system may allow for communication between different levels - from the central power governor 28 down through the rack power governors 34 to the individual network devices 36. This structure enables coordinated power management and network traffic control across the data center 12.

In some cases, the central power governor 28 may send high-level power allocation decisions to the rack power governors 34 and network devices 36, which then implement more granular power management based on those decisions. For example:

The central power governor 28 may determine that a particular rack 32 needs to reduce its overall power consumption by 20% due to increased demand elsewhere in the data center 12. The rack power governor 34 may receive this decision and implement it by adjusting power allocations across the network devices 36 in that rack 32. Some network devices 36 may have their power budgets reduced more than others based on their current utilization and relative priority.

Individual network devices 36 may receive power allocation decisions from both the central power governor 28 and rack power governors 34. A network switch may be instructed to reduce its power consumption by 15%. The switch's power management controller 70 may then decide how to achieve this reduction, such as by scaling down the clock speed of certain ports, placing unused interfaces into a low-power state, or adjusting the voltage of its internal components.

The central power governor 28 may send a decision to increase power allocation to a specific area of the data center 12 experiencing high network congestion. Rack power governors 34 in that area may redistribute power from less utilized devices to those handling more traffic. Network devices 36 like routers may then use the additional power to activate more processing cores or increase their packet processing capabilities.

In some implementations, the central power governor 28 may provide time-based power profiles to rack governors 34 and network devices 36. These profiles may allocate more power during expected peak usage hours and less during typically quiet periods. Rack governors 34 and network devices 36 may then fine-tune their power management strategies within these broader guidelines.

The central power governor 28 may make power allocation decisions based on facility-wide thermal management goals. Rack governors 34 may receive instructions to reduce heat generation in certain areas. They may then selectively lower power to network devices 36 generating the most heat, while network devices 36 may adjust their cooling systems or throttle performance to meet these thermal targets.

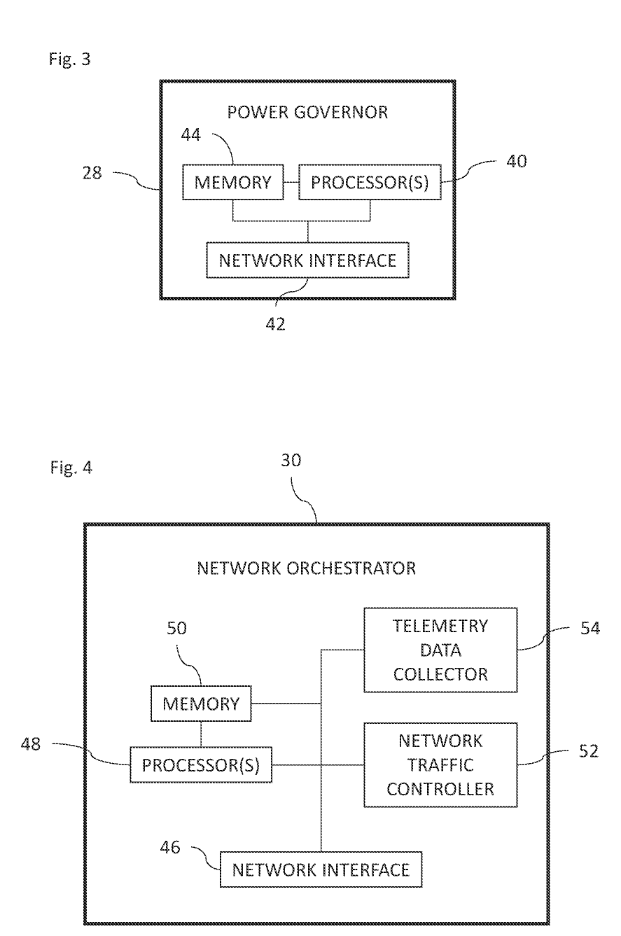

Reference is now made to FIGS. 3 and 4. FIG. 3 shows the central power governor 28, and may include one or more processors 40, a network interface 42, and a memory 44. The processor(s) 40 may execute instructions stored in the memory 44 to perform power management functions. The network interface 42 may enable communication with other components of the system 10.

FIG. 4 shows network orchestrator 30 and may include one or more processors 48, a network interface 46, a memory 50, a network traffic controller 52, and a telemetry data collector 54. The processor(s) 48 may execute instructions stored in the memory 50 to manage network traffic and collect telemetry data. The network interface 46 may enable communication with other system components.

The central power governor 28 and network orchestrator 30 may work together to coordinate power allocation and network traffic management. In some cases, the central power governor 28 may dynamically reallocate power budgets among network devices based on information received from the network orchestrator 30.

The network traffic controller 52 may adjust network traffic parameters in response to power allocation decisions from the central power governor 28. The telemetry data collector 54 may gather performance metrics and operational statistics from network devices 36.

In some cases, the central power governor 28 may send early notifications of impending power budget changes to the network orchestrator 30 and/or network devices 36. The network traffic controller 52 may then proactively adjust network parameters based on these notifications.

The central power governor 28 may coordinate power state changes in network devices with the network traffic controller 52 to avoid race conditions. For example, before reducing power to a network device, the central power governor 28 may notify the network traffic controller 52 to reroute traffic or adjust data flow rates.

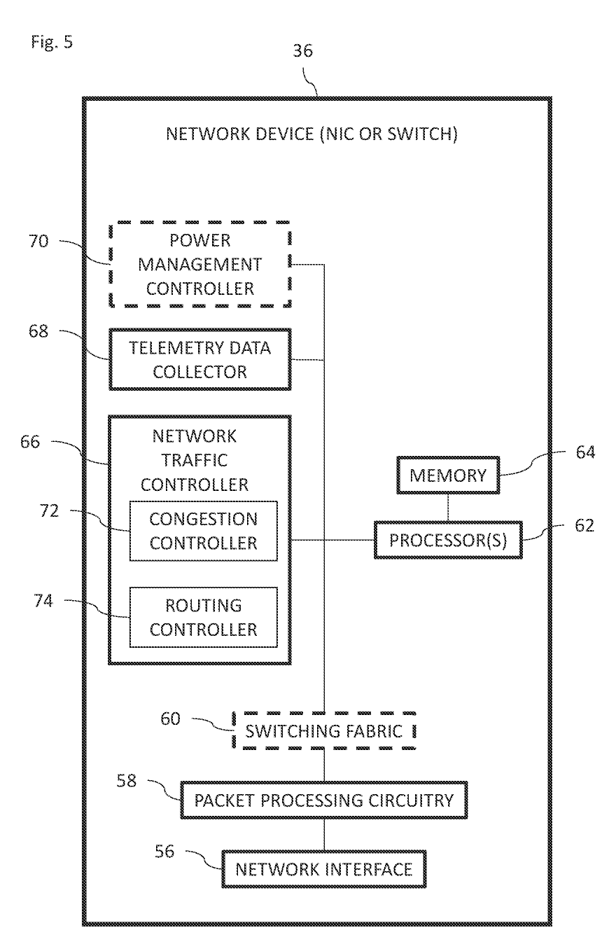

Reference is now made to FIG. 5, which is a block diagram illustrating the architecture of one of the network devices 36. The network device 36 may include various components that enable it to process network traffic and manage power consumption efficiently.

A network interface 56 may be included in the network device 36 to connect to a network and facilitate the transmission and reception of data packets. The network interface 56 may be coupled to packet processing circuitry 58, which may be responsible for processing incoming and outgoing network packets.

In some cases, when the network device 36 is configured as a network switch, the network device 36 may include switching fabric 60. The switching fabric 60 may be connected to the packet processing circuitry 58 and may be used for routing data between different ports or interfaces within the network device 36.

The network device 36 may contain one or more processors 62 and memory 64. The processor(s) 62 may execute instructions stored in the memory 64, and the memory 64 may store data used by the processor(s) 62 during operation of the network device 36.

A network traffic controller 66 may be included in the network device 36 to manage the flow of traffic through the device 36. The network traffic controller 66 may include a congestion controller 72 and a routing controller 74. The congestion controller 72 may adjust data flow rates based on various factors, including received power allocation decisions. The routing controller 74 may make network routing decisions, which may also be influenced by received power allocation decisions.

A telemetry data collector 68 may be present in the network device 36 to gather operational statistics and metrics. These metrics may be sent to other components in the system, such as an orchestrator or power governors, to aid in system-wide decision making.

The network device 36 may also include a power management controller 70. The power management controller 70 may regulate power consumption of the various components within the network device 36. In some cases, the power management controller 70 may adjust power consumption based on power decisions received from external power governors.

The components within the network device 36 may interact through the switching fabric 60, which may provide interconnectivity between the various processing elements. The network interface 56, packet processing circuitry 58, and switching fabric 60 may form a data path through the network device 36, while the processor(s) 62, memory 64, and controllers (66, 68, 70, 72, 74) may provide control and management functions.

In some cases, the telemetry data collector 68 may monitor performance metrics that can be used by the power management controller 70 and network traffic controller 66 to optimize the operation of the network device 36. This may allow the network device 36 to adapt its behavior based on current network conditions and power constraints.

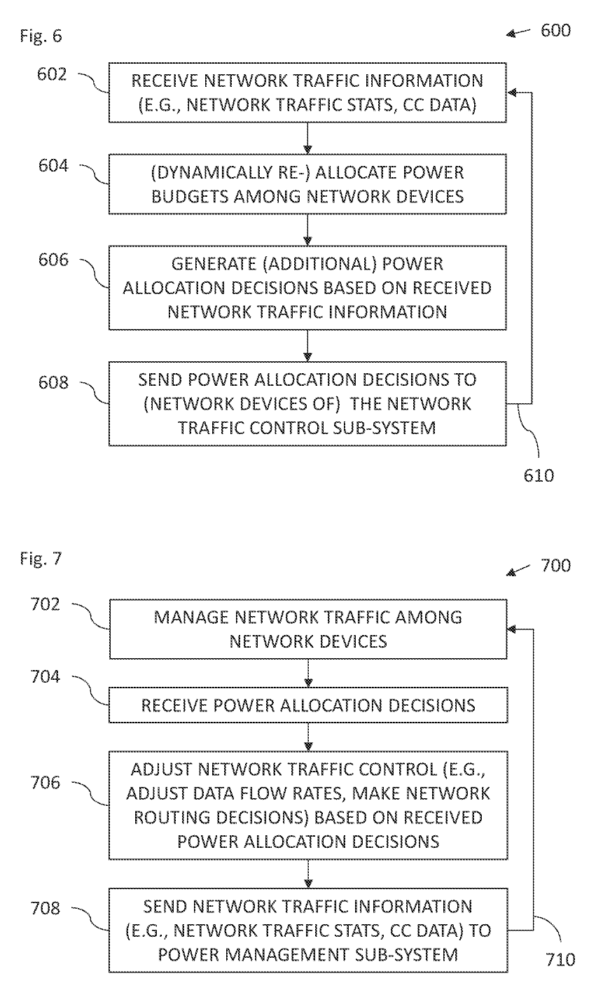

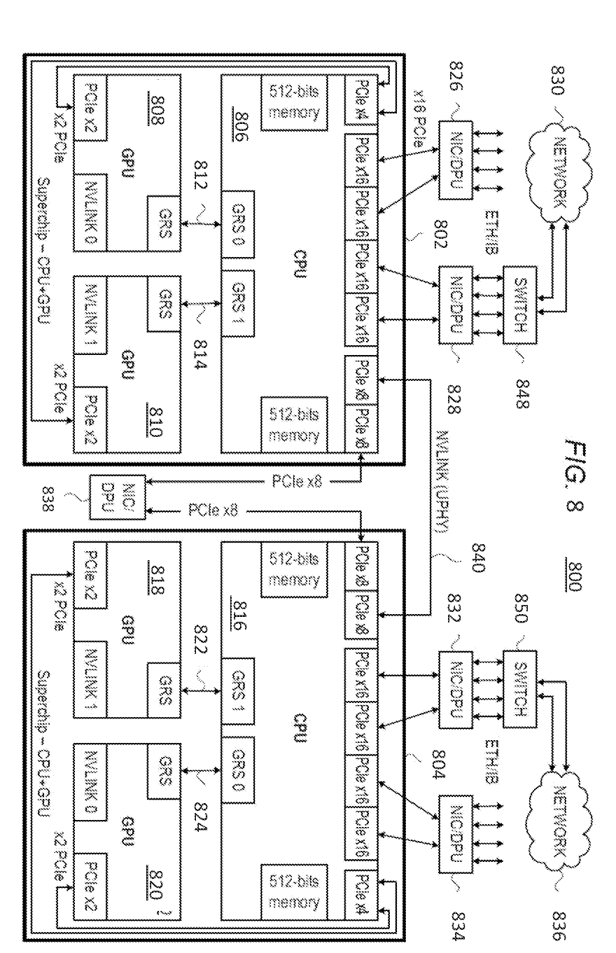

Reference is now made to FIGS. 6 and 7, which are flowcharts illustrating methods for managing power allocation and network traffic in a network system.

FIG. 6 depicts a method 600 for managing power allocation. The method 600 may be performed by the processor(s) 40 of central power governor 28 and/or the rack power governor 34 being configured to perform the steps of method 600.

The method 600 may include a block 602 for receiving network traffic information. This network traffic information may include network traffic statistics and/or congestion control data. In some cases, the network traffic statistics may provide insights into overall network performance and utilization. The congestion control data may offer specific information about network congestion points and traffic flow rates.

At a block 604, the method 600 may involve dynamically reallocating power budgets among network devices based on the received network traffic information. This reallocation may take into account the current network conditions as indicated by the information received.

The method 600 may proceed to a block 606, where additional power allocation decisions may be generated based on the revised budgets which are based on the received network traffic information. In some cases, these additional power allocation decisions may be based on the received network traffic statistics and congestion control data. By considering this detailed network information, the power management subsystem may make more informed decisions about power distribution across the network.

At a block 608, the power allocation decisions may be sent to network devices of the network traffic control subsystem. These decisions may guide how power is distributed and utilized across the network infrastructure.

A line 610 in FIG. 6 indicates that the steps of blocks 602-608 may be repeated intermittently. This repetition may allow for continuous adjustment of power allocation based on changing network conditions. The steps of method 600 may be performed in any suitable order.

FIG. 7 illustrates a method 700 for managing network traffic in response to power allocation decisions. The method 700 may be performed by the processor(s) 48 of network orchestrator 30 and/or the processor(s) 62 of network device 36 being configured to perform the steps of method 700.

The method 700 may begin at a block 702 with managing network traffic among network devices based on current congestion control and routing decisions.

At a block 704, the method 700 may involve receiving power allocation decisions. These decisions may come from the power management subsystem 14 and reflect the current power distribution strategy.

The method 700 may proceed to a block 706, where network traffic control may be adjusted based on the received power allocation decisions. This adjustment may include modifying data flow rates and making new network routing decisions. In some cases, the network traffic control subsystem may proactively adjust network parameters based on early notifications of impending power budget changes. For example, the network traffic control subsystem may proactively adjust transmission rates based on these early notifications.

At a block 708, network traffic information, such as network traffic statistics and congestion control data, may be sent to the power management subsystem 14. This information may be used by the power management subsystem 14 to generate additional power allocation decisions in future iterations of the power management process.

A line 710 in FIG. 7 indicates that the steps of blocks 702-708 may be repeated intermittently. This repetition may allow for continuous adjustment of network traffic control based on changing power allocation decisions and network conditions. The steps of method 700 may be performed in any suitable order.

By implementing these methods, the system 10 may maintain a dynamic balance between power allocation and network traffic management, potentially leading to more efficient overall system operation.

In some cases, the power management subsystem may utilize machine learning algorithms to predict future congestion patterns and proactively adjust power allocations. These algorithms may analyze historical data on network traffic, congestion events, and power usage to identify trends and patterns. By anticipating potential congestion issues before they occur, the system 10 may preemptively reallocate power resources to mitigate performance impacts.

The system 10 may be implemented in various computing environments beyond traditional data centers 12. For example, the power and network management techniques may be applied in supercomputing facilities and high-performance computing (HPC) clusters. In these environments, optimizing power allocation and network traffic control may be particularly critical due to the intensive computational workloads and high-bandwidth communication requirements.

In some implementations, the power management subsystem 14 may utilize time-based power profiles that anticipate known traffic patterns or workload schedules. These profiles may allocate more power to network components during peak usage hours and reduce power during typically quiet periods. The system 10 may dynamically adjust these profiles based on observed deviations from expected patterns, allowing for adaptive optimization over time.

The system 10 may also be deployed in cloud computing environments to optimize resource allocation across distributed data centers. In this context, the power management and network traffic control mechanisms may coordinate across multiple physical locations to balance workloads, manage inter-data center traffic, and optimize overall power consumption.

To enhance congestion detection and management, the system may utilize additional congestion metrics beyond rate counters and round-trip time (RTT) measurements. These may include queue depth information from switches, link utilization percentages, and application-specific latency measurements. By incorporating a more comprehensive set of metrics, the system may develop a more nuanced understanding of network conditions and make more informed power allocation decisions.

Reference is now made to FIG. 8, which is a block diagram that schematically illustrates a computing system 800, e.g., a data center or a High-Performance Computing (HPC) cluster, in accordance with an embodiment of the present disclosure.

System 800 comprises a plurality of subsystems, e.g., multiple processing devices coupled to each other, multiple network devices, and multiple networks, according to at least one embodiment. Computing system 800 is designed with multiple integrated circuits (referred to as processing devices), where each integrated circuit can include one or more CPUs and GPUs, forming a powerful and flexible architecture.

The various processing devices are interconnected via an NVLink or other high-speed interconnect, enabling high-speed communication between the subsystems, and are also connected through a NIC or DPU to ensure efficient data transfer across computing system 800 and to one or more external networks 830, 836. In the present example, system 800 comprises a packet switch 848 that connects NIC/DPU 828 to network 830, and a packet switch 850 that connects NIC/DPU 832 to network 836.

The coupling of processing devices through NVLink allows for seamless data exchange and parallel processing, enhancing overall computational performance. The processing devices are connected to multiple networks through one or more network interface cards (NICs) or DPUs, enabling the system to handle complex, multi-network tasks with high bandwidth and low latency. This configuration is highly suitable for demanding applications that require significant processing power, such as artificial intelligence (AI), machine learning (ML), and data-intensive computing, while ensuring robust connectivity and scalability across various networked environments. The integrated circuits of the computing system 800 can include one or more CPUs and one or more GPUs.

FIG. 8 also demonstrates an example architecture of a multi-GPU architecture. As illustrated in the figure, computing system 800 includes a processing device 802 with a multi-GPU architecture. In particular, processing device 802 may be a system-on-chip and includes multiple subsystems such as a CPU 806, a GPU 808, and a GPU 810. CPU 806 can be coupled to GPU 808 via a die-to-die (D2D) or chip-to-chip (C2C) interconnect 812, such as a Ground-Referenced Signaling interconnect (GRS interconnect). CPU 806 can be coupled to GPU 810 via a D2D or C2C interconnect 814. CPU 806 can also couple to GPU 808 and GPU 810 via PCIe interconnects.

CPU 806 can be coupled to one or more NICs or DPUs, which are coupled to one or more networks. For example, as illustrated in FIG. 8, CPU 806 is coupled to a first NIC/DPU 826, which is coupled to a network 830. CPU 806 is also coupled to a second NIC/DPU 828, which is coupled to network 830 via switch 848. NIC/DPU 826 and NIC/DPU 828 can be coupled to network 830 over Ethernet (ETH), NVLINK or InfiniBand (IB) connections, for example.

Computing system 800 also includes a processing device 804 with a multi-GPU architecture. In particular, processing device 804 includes multiple subsystems including a CPU 816, a GPU 818, and a GPU 820. CPU 816 can be coupled to GPU 818 via a D2D or C2C interconnect 822. CPU 816 can be coupled to GPU 820 via a D2D or C2C interconnect 824. CPU 816 can also couple to GPU 818 and GPU 820 via PCIe interconnects. CPU 816 can be coupled to one or more NICs or DPUs, which are coupled to one or more networks. For example, as illustrated in FIG. 8, CPU 816 is coupled to a first NIC/DPU 832, which is coupled to a network 836. CPU 816 is also coupled to a second NIC/DPU 834, which is coupled to network 836 via switch 850. NIC/DPU 832 and NIC/DPU 834 can be coupled to network 836 over Ethernet (ETH), NVLINK or InfiniBand (IB) connections.

In at least one embodiment, processing device 802 and processing device 804 can communicate with each other via a NIC/DPU 838, such as over PCIe interconnects. Processing device 802 and processing device 804 can also communicate with each other over a high-bandwidth communication interconnect 840, such as an NVLink interconnect or other high-speed interconnects. The packet switches in FIG. 8 may comprise, for example, Nvidia Quantum-2 switches. The NICs/DPUs in the figure may comprise, for example, Nvidia Bluefield DPUs.

The NIC may include any of the following: an Ethernet Port (RJ45 Connector), which is the physical interface where the network cable (usually an Ethernet cable) connects to the NIC and is used for wired network connections; packet processing hardware or circuitry, which is responsible for handling network communication and processes incoming and outgoing data packets and manages the network interface functions; a memory (such as RAM or ROM) to store temporary data, such as network packet buffers, configuration settings, and firmware, and helps in speeding up data transfer and processing; firmware, which is software programmed into the NIC's memory and controls the hardware operations and may perform firmware updates to improve performance or add new features to the NIC; LED Indicators that provide visual indicators of network status, common indicators including power status, network activity, and link speed; a bus Interface (e.g., PCI or PCIe) to connect the NIC to the host computer’s motherboard; a processor to handle network processing tasks as well as other processing tasks to offload work from the main CPU of the host device and improve network performance; a heat sink or cooling mechanism (e.g., for high-performance NICs), especially those used in servers, to prevent overheating; power management circuitry to ensure the NIC receives the correct amount of power and manages power consumption efficiently; and/or connector pins and circuitry including internal connections and pathways that route signals between the NIC's components.

The packet processing hardware or circuitry is the central component of the NIC and handles network communications. It may include several key components that work together to manage and process network data, such as any one or more of the following: MAC (Media Access Control) Layer, which is responsible for handling the data link layer of the OSI model and manages how data packets are formatted, addressed, and transmitted over the network; MAC address register, which stores the unique hardware address (MAC address) of the NIC; a frame buffer that temporarily holds data frames as they are being processed; a PHY (Physical Layer) Interface that interfaces with the physical medium (such as Ethernet cables) and is responsible for the actual transmission and reception of data bits over the network; a transceiver that converts data between the digital signals used by the MAC layer and the analog signals used for transmission over the network medium; DMA (Direct Memory Access) Controller that manages data transfers between the NIC and the computer’s memory without involving the CPU and helps to offload processing tasks from the CPU and improve data transfer efficiency; a packet Processing Engine that handles the encapsulation and decapsulation of network packets, and processes incoming and outgoing packets, managing tasks like error checking and packet filtering; buffer management, which includes memory areas for storing packets temporarily, such as transmit buffers to store packets that are being sent from the computer to the network, receive buffers to store packets received from the network before they are processed by the system; an interrupt controller that manages and generates interrupts to notify the CPU of events such as packet reception or transmission completion and helps in efficient handling of network events; a clock generator, which provides timing signals for the various components of the NIC to synchronize their operations; a power management unit to regulate power consumption and manages power-saving features of the NIC chip to improve energy efficiency; error handling and correction logic, which detects and corrects errors in data transmission and reception, and may include features for error-checking protocols like CRC (Cyclic Redundancy Check); configuration registers that store configuration settings and parameters that control the NIC’s operation, such as speed settings, interrupt configurations, and buffer sizes; firmware/ROM that contains the embedded software that controls the NIC’s operations and manages network protocols.

The network switch may include any of the following: ports where network cables connect; switching fabric that manages data transfer between ports; a MAC address table that stores device addresses and port information; a forwarding engine that directs data packets to the correct ports; buffer memory that temporarily holds data to manage traffic; a management processor that handles configuration and monitoring in managed switches; a power supply that provides electrical power; a cooling system that keeps the switch from overheating; firmware that controls the switch; LED Indicators that show status and activity; and networking modules (in modular switches) that allow for additional ports or features.

In practice, some or all of these functions may be combined in a single physical component or, alternatively, implemented using multiple physical components. These physical components may comprise hard-wired or programmable devices, or a combination of the two. In some embodiments, at least some of the functions of the processing circuitry may be carried out by a programmable processor under the control of suitable software. This software may be downloaded to a device in electronic form, over a network, for example. Alternatively, or additionally, the software may be stored in tangible, non-transitory computer-readable storage media, such as optical, magnetic, or electronic memory.

The flowchart and block diagrams in the figures illustrate the architecture, functionality, and operation of possible implementations of systems, methods and computer program products according to various examples of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. The descriptions of the various examples of the present disclosure have been presented for purposes of illustration, but are not intended to be exhaustive or limited to the examples disclosed. Many modifications and variations will be apparent to those of ordinary skill in the art without departing from the scope and spirit of the described examples.

As used herein, the singular form "a", "an" and "the" include plural references unless the context clearly dictates otherwise.

Various features of the disclosure which are, for clarity, described in the contexts of separate embodiments may also be provided in combination in a single embodiment. Conversely, various features of the disclosure which are, for brevity, described in the context of a single embodiment may also be provided separately or in any suitable sub-combination.

The embodiments described above are cited by way of example, and the present disclosure is not limited by what has been particularly shown and described hereinabove. Rather the scope of the disclosure includes both combinations and sub-combinations of the various features described hereinabove, as well as variations and modifications thereof which would occur to persons skilled in the art upon reading the foregoing description and which are not disclosed in the prior art.

What is claimed is:

1. A system for managing network devices, comprising:
a power management subsystem to allocate power budgets to the network devices;
a network traffic control subsystem to manage network traffic among the network devices; and
a communication interface between the power management subsystem and the network traffic control subsystem,
wherein the power management subsystem is to send power allocation decisions to the network traffic control subsystem, and the network traffic control subsystem is to adjust network traffic control based on the power allocation decisions.

2. The system of claim 1, wherein the network traffic control subsystem is to send network traffic information to the power management subsystem, and the power management subsystem is to generate additional power allocation decisions based on the network traffic information.

3. The system of claim 2, wherein the network traffic information includes congestion control data, and the power management subsystem is to generate the additional power allocation decisions based on the congestion control data.

4. The system of claim 2, wherein the network traffic information includes network traffic statistics, the power management subsystem is to generate the additional power allocation decisions based on the network traffic statistics.

5. The system of claim 1, wherein the network traffic control subsystem includes a congestion controller to adjust data flow rates based on the power allocation decisions.

6. The system of claim 1, wherein the network traffic control subsystem includes a routing controller to make network routing decisions based on the power allocation decisions.

7. The system of claim 1, wherein the power management subsystem is to dynamically reallocate power budgets among the network devices.

8. The system of claim 1, wherein the system is implemented in a data center environment to manage power consumption and network performance across multiple server racks and network devices.

9. The system of claim 1, wherein the power management subsystem is to send early notifications of impending power budget changes to the network traffic control subsystem, and the network traffic control subsystem is to proactively adjust network parameters based on the early notifications.

10. The system of claim 9, wherein the network traffic control subsystem is to proactively adjust transmission rates based on the early notifications.

11. The system of claim 9, wherein the power management subsystem is to coordinate power state changes in the network devices with the network traffic control subsystem to avoid race conditions and improve overall system performance.

12. The system of claim 1, wherein the network devices include the network traffic control subsystem.

13. The system of claim 1, wherein the power management subsystem is to provide multiple levels of power management and includes: a centralized power governor; and distributed power management controllers disposed in the network devices.

14. The system of claim 13, wherein the centralized power governor is implemented at a datacenter level or a rack level.

15. A system for managing network devices, comprising:
a power management subsystem to allocate power budgets to the network devices;
a network traffic control subsystem to manage network traffic among the network devices; and
a communication interface between the power management subsystem and the network traffic control subsystem, wherein the network traffic control subsystem is to send network traffic information to the power management subsystem, and the power management subsystem is to generate power allocation decisions based on the network traffic information and send the power allocation decisions to the network traffic control subsystem.

16. The system of claim 15, wherein the network traffic information includes congestion control data, and the power management subsystem is to generate the power allocation decisions based on the congestion control data.

17. The system of claim 15, wherein the network traffic information includes network traffic statistics, and the power management subsystem is to generate the power allocation decisions based on the network traffic statistics.

18. The system of claim 15, wherein the network traffic control subsystem includes a congestion controller to adjust data flow rates based on the power allocation decisions.

19. The system of claim 15, wherein the network traffic control subsystem includes a routing controller to make network routing decisions based on the power allocation decisions.

20. The system of claim 15, wherein the power management subsystem is to dynamically reallocate power budgets among the network devices.

21. The system of claim 15, wherein the system is implemented in a data center environment to manage power consumption and network performance across multiple server racks and network devices.

22. The system of claim 15, wherein the power management subsystem is to send early notifications of impending power budget changes to the network traffic control subsystem, and the network traffic control subsystem is to proactively adjust network parameters based on the early notifications.

23. The system of claim 22, wherein the network traffic control subsystem is to proactively adjust transmission rates based on the early notifications.

24. The system of claim 22, wherein the power management subsystem is to coordinate power state changes in the network devices with the network traffic control subsystem to avoid race conditions and improve overall system performance.

25. The system of claim 15, wherein the network devices include the network traffic control subsystem.

26. The system of claim 15, wherein the power management subsystem is to provide multiple levels of power management and includes: a centralized power governor; and distributed power management controllers disposed in the network devices.

27. The system of claim 26, wherein the centralized power governor is implemented at a datacenter level or a rack level.

28. A method for managing network devices, comprising:
allocating power budgets to the network devices using a power management subsystem;
managing network traffic among the network devices using a network traffic control subsystem;
sending power allocation decisions from the power management subsystem to the network traffic control subsystem through a communication interface; and
adjusting network traffic control by the network traffic control subsystem based on the power allocation decisions.
